(19) United States
(12) Patent Application Publication
(10) Pub. No.: US 2024/0257268 A1
(43) Pub. Date: Aug. 1, 2024

(54) BLOCKCHAIN-BASED DATA PROCESSING

(71) Applicant: Alipay (Hangzhou) Information Technology Co., Ltd., Hangzhou (CN)

(72) Inventors: Wenhu KAN, Hangzhou (CN); Yue WANG, Hangzhou (CN); Kun WU, Hangzhou (CN); Jianhui HUA, Hangzhou (CN); Weiqiang LV, Hangzhou (CN)

(21) Appl. No.: 18/561,260

(22) PCT Filed: Jul. 1, 2022
(86) PCT No.: PCT/CN2022/103361

§ 371 Date: Nov. 15, 2023

(30) Foreign Application Priority Data
May 25, 2021 (CN) 202110573725.X

(51) Int. Cl. G06Q 40/12; G06Q 20/04; G06Q 20/38

(52) U.S. Cl. CPC G06Q 40/123; G06Q 20/045; G06Q 20/389

(57) ABSTRACT

A blockchain-based data processing method is applied to a blockchain node in a blockchain. The blockchain is used to store a payment record and an electronic ticket that are obtained after an institution member makes a payment based on a reimbursement code of an institution. The method includes: querying a payment record and an electronic ticket of a reimbursement payment event of the institution member in the blockchain after a write-off condition of the institution member is triggered; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

### TECHNICAL FIELD

This specification relates to the field of blockchain technologies, and in particular, to a blockchain-based data processing method and apparatus.

### BACKGROUND

With development of Internet technologies, electronic tickets are widely applied. Like an ordinary paper ticket, the electronic ticket has a code issued by a tax institution. Therefore, the electronic ticket has the same credential effect as the ordinary paper ticket, but the electronic ticket is more convenient than the ordinary paper ticket in aspects such as ticket issuance and reimbursement. In a process of performing expense reimbursement by using a ticket, it is necessary to fill in an electronic report form such as a reimbursement application form, and then the reimbursement application form for which filling is completed is submitted to a reviewer for review. After review succeeds, the ticket is reimbursed. An entire reimbursement process is cumbersome. In the reimbursement process, a ticket item type filling error, or the like usually occurs, and both a person who applies for ticket reimbursement and the reviewer need to spend much time and energy.

### SUMMARY

One or more embodiments of this specification provide a blockchain-based data processing method. The blockchain-based data processing method is applied to a blockchain node in a blockchain. The blockchain is used to store a payment record and an electronic ticket that are obtained after an institution member makes a payment based on a reimbursement code of an institution. The method includes: querying a payment record and an electronic ticket of a reimbursement payment event of the institution member in the blockchain after a write-off condition of the institution member is triggered; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

One or more embodiments of this specification provide a blockchain-based data processing apparatus, running on a blockchain node in a blockchain. The blockchain is used to store a payment record and an electronic ticket that are obtained after an institution member makes a payment based on a reimbursement code of an institution. The apparatus includes: an event data query module, configured to query a payment record and an electronic ticket of a reimbursement payment event of the institution member in the blockchain after a write-off condition of the institution member is triggered; an event association module, configured to perform association processing of the reimbursement payment event based on the queried payment record and electronic ticket, to obtain to-be-written-off data; a write-off processing module, configured to perform write-off processing on the to-be-written-off data, to generate a reimbursement form of the institution member, and perform on-chain processing; and an accounting processing module, configured to perform accounting processing based on the reimbursement form, and upload an obtained accounting voucher to the blockchain for tax declaration processing.

One or more embodiments of this specification provide a blockchain-based data processing device, including a processor and a storage configured to store computer-executable instructions. When the computer-executable instructions are executed, the processor is enabled to perform the following operations: querying a payment record and an electronic ticket of a reimbursement payment event of an institution member in a blockchain after a write-off condition of the institution member is triggered, where the blockchain is used to store a payment record and an electronic ticket that are obtained after the institution member makes a payment based on a reimbursement code of an institution; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

One or more embodiments of this specification provide a storage medium, configured to store computer-executable instructions. When the computer-executable instructions are executed, the following procedure is implemented: querying a payment record and an electronic ticket of a reimbursement payment event of an institution member in a blockchain after a write-off condition of the institution member is triggered, where the blockchain is used to store a payment record and an electronic ticket that are obtained after the institution member makes a payment based on a reimbursement code of an institution; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

### BRIEF DESCRIPTION OF DRAWINGS

To describe the technical solutions in one or more embodiments of this specification or in the conventional technology more clearly, the following briefly describes the accompanying drawings needed for describing the embodiments or the conventional technology. Clearly, the accompanying drawings in the following description merely show some embodiments of this specification, and a person of ordinary skill in the art can still derive other drawings from these accompanying drawings without creative efforts.

FIG. 1 is a processing flowchart of a blockchain-based data processing method according to one or more embodiments of this specification;

FIG. 2 is a processing flowchart of a blockchain-based data processing method applied to an institution reimbursement scenario according to one or more embodiments of this specification;

FIG. 3 is a schematic diagram of a blockchain-based data processing apparatus according to one or more embodiments of this specification; and

FIG. 4 is a schematic diagram of a structure of a blockchain-based data processing device according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

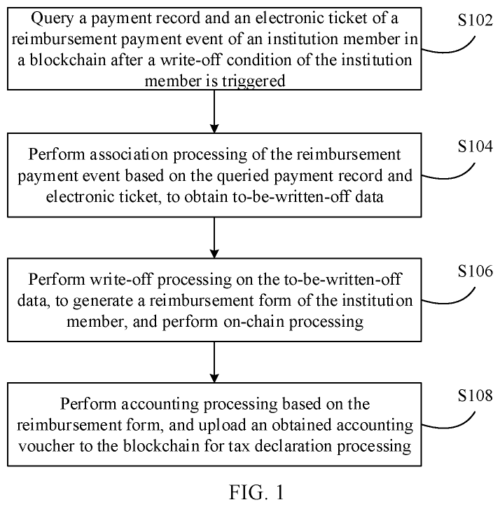

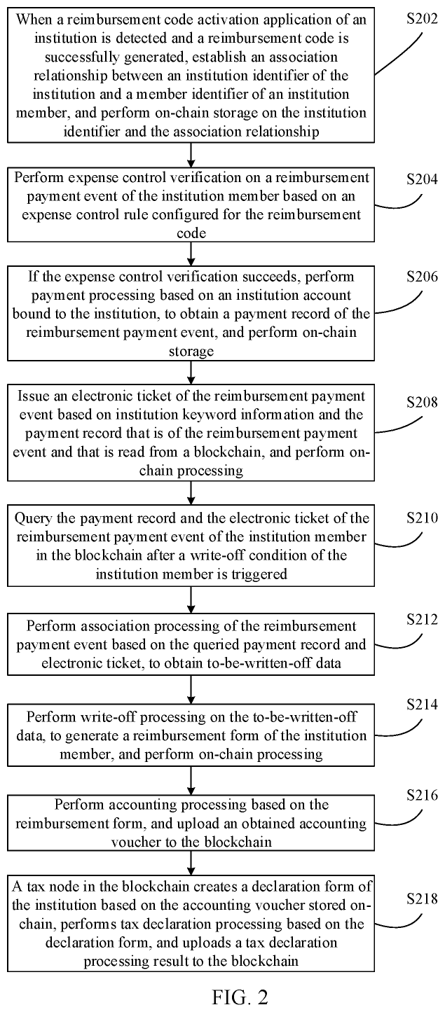

This specification provides an embodiment of a blockchain-based data processing method. FIG. 1 is a processing flowchart of a blockchain-based data processing method according to an embodiment. FIG. 2 is a processing flowchart of a blockchain-based data processing method applied to an institution reimbursement scenario according to an embodiment.

With reference to FIG. 1, the blockchain-based data processing method provided in this embodiment is applied to a blockchain node in a blockchain. The blockchain is used to store a payment record and an electronic ticket that are obtained after an institution member makes a payment based on a reimbursement code of an institution. The method specifically includes step S102 to step S108.

Step S102: Query a payment record and an electronic ticket of a reimbursement payment event of the institution member in the blockchain after a write-off condition of the institution member is triggered.

According to the blockchain-based data processing method provided in this embodiment, the blockchain is used as a core, the payment record and the electronic ticket that are obtained after the institution member makes a payment by using the reimbursement code are stored by using the blockchain, the reimbursement payment event of the institution member is combined, to-be-written-off data of an obtained combination is written off, to generate a reimbursement form of the institution member, and finally, accounting processing of the institution is performed based on the reimbursement form, to obtain an accounting voucher used to perform tax reimbursement processing. In this way, a trust problem generated between the institution and an institution employee due to reconciliation is avoided, and trust between the institution and the institution employee is improved. In addition, institution accounting is prevented from being tampered with, and reliability of institution accounting is improved.

The institution described in this embodiment includes various forms of organizations, including an enterprise, a public institution, a social group, a firm, and the like. In addition, the institution not only includes an organization at a current level, but also includes an internal organization of the institution, for example, an enterprise department or a division. The institution member includes institution staff and related personnel.

The reimbursement code is an institution code that is set by the institution for a payment, ticket issuance, and reimbursement of the institution member. The institution code can uniquely identify the institution. An existence form of the institution code can be an identification code, for example, a two-dimensional code, a barcode, or an audio code. Integrated processing of payment, ticket issuance, and reimbursement can be implemented based on the reimbursement code. In addition, the reimbursement code can be further used to identify a member identity of the institution member in the institution. For example, the reimbursement code is used as a digital work card of an enterprise employee, and the enterprise employee can obtain, by using the reimbursement code as a voucher, benefits and subsidies issued by the enterprise.

The write-off condition is a trigger condition for triggering write-off of a reimbursement payment record or a behavior of the institution member. The write-off condition of the institution member includes at least one of the following: A reimbursement limit allocated by the institution to the institution member for the reimbursement code is exhausted, and a ticket application control of the reimbursement payment event of the institution member is triggered. The ticket application control is configured on a payment completion page generated after a payment of the reimbursement payment event is completed.

In this embodiment, the blockchain is further used to store an institution identifier of the institution and an association relationship between the institution and the institution member. Specifically, before the payment record and the electronic ticket of the institution member are stored in the blockchain, on-chain storage is performed on the institution identifier of the institution and the association relationship between the institution and the institution member. Specifically, in an on-chain storage process, the institution identifier of the institution and a member identifier of the institution member of the institution are obtained when a reimbursement code activation application of the institution is detected and the reimbursement code is successfully generated; and an association relationship between the institution identifier and the member identifier is established, and the institution identifier and the association relationship are uploaded to the blockchain.

In an optional implementation provided in this embodiment, in a process of activating the reimbursement code of the institution, whether the institution is an authenticated institution or whether an institution member submitting a reimbursement code activation request is an institution owner (for example, an enterprise owner) of the institution is detected based on the reimbursement code activation request. If yes, the reimbursement code is generated, and is delivered to the institution or the institution member submitting the reimbursement code activation request, and a binding relationship between the institution and a submitted institution account is established, so that the institution member subsequently performs deduction from the institution account in a reimbursement process. If no, it indicates that the institution does not meet a reimbursement code activation condition, and no processing is performed or reimbursement code activation failure reminder information is delivered to the institution.

When the reimbursement code of the institution is activated, the institution can actively invite the institution member to grant use permission for the reimbursement code, so that the institution member makes a payment, and performs ticket issuance and reimbursement in scenarios such as travel on business, a business trip, entertainment, team building, office procurement, and benefit/subsidy issuing by using the reimbursement code. A process in which the institution actively invites the institution member to grant the use permission for the reimbursement code specifically includes: sending an activation invitation of the reimbursement code to the institution member based on an activation request submitted by the institution for the institution member; performing identity verification processing on the institution member when a confirmation instruction submitted by the institution member for the activation invitation is detected; and when the identity verification processing succeeds, establishing a mapping relationship between the institution member and institution keyword information of the institution, and uploading the mapping relationship to the blockchain. The institution keyword information includes title information of the institution.

After the institution grants the use permission for the reimbursement code to the institution member, the institution member can access the reimbursement code based on a reimbursement code service provided by a third-party application. For example, an enterprise employee to which permission for the reimbursement code is granted can access a reimbursement code of the enterprise based on a reimbursement code service of a payment application installed on a terminal of the enterprise employee. The reimbursement payment event is an event triggered in a payment process performed by the institution member by using the reimbursement code of the institution.

In specific implementation, a prerequisite for querying the payment record and the electronic ticket from the blockchain is that the payment record and the electronic ticket are stored in the blockchain in advance. Therefore, before the payment record and the electronic ticket are queried, the payment record and the electronic ticket need to be generated and on-chain storage needs to be performed. Specifically, generation and on-chain storage of the payment record of the reimbursement payment event specifically include: performing expense control verification on the reimbursement payment event of the institution member based on an expense control rule configured for the reimbursement code; and if the expense control verification succeeds, performing payment processing based on an institution account bound to the institution, to obtain the payment record of the reimbursement payment event, and uploading the payment record to the blockchain.

In addition, when the expense control verification fails, to ensure that processing of the reimbursement payment event of the institution member is not interrupted, reimbursement failure reminder information is delivered to the institution member, funds are transferred out from a member account of the institution member, and the transferred-out funds are transferred to an account of a merchant.

Optionally, the expense control verification is implemented in the following manner: determining a target reimbursement category that matches the reimbursement payment event in at least one reimbursement category of the expense control rule; verifying whether element information carried in the reimbursement payment event falls within a value range of an expense control element associated with the target reimbursement category; and if yes, determining that verification on the reimbursement payment event in terms of the target reimbursement category succeeds, that is, a verification result of performing expense control verification on the reimbursement payment event is that the verification succeeds; or if no, determining that verification on the reimbursement payment event in terms of the target reimbursement category fails, that is, a verification result of performing expense control verification on the reimbursement payment event is that the verification fails.

The expense control rule is used to verify whether an order submitted by the institution member meets a reimbursement condition set by the institution. For example, an enterprise code of the enterprise can be used by the enterprise employee to make a payment in scenarios such as travel on business, a business trip, entertainment, team building, office procurement, and benefit/subsidy issuing. A deducted expense generated by a payment that meets a reimbursement condition set by the enterprise is borne by the enterprise, to implement automatic reimbursement or an employee discount. Optionally, the expense control rule is configured with at least one reimbursement category of the reimbursement code, and the reimbursement category is associated with at least one expense control element. The expense control element includes at least one of the following: a time element, an object compliance element, a limit element, and a location element. The reimbursement category includes but is not limited to travel on business, a business trip, entertainment, team building, office procurement, and benefit/subsidy issuing.

The time element is used to verify whether a consumption time of reimbursement that is applied for by the institution member meets a stipulation of the institution. The object compliance element is used to verify whether a consumer of reimbursement that is applied for by the institution member meets a stipulation of the institution. For example, the enterprise stipulates that expense incurred by taking a company shuttle bus or a bus on a specific bus line can be reimbursed. If a vehicle that the enterprise employee takes does not meet a stipulation, reimbursement cannot be performed. The limit element is used to verify whether an amount of reimbursement that is applied for by the institution member meets a stipulation of the institution. The location element is used to verify whether geographic location information of a consumption location of reimbursement that is applied for by the institution member meets a stipulation of the institution.

It is worthwhile to note that in this embodiment, to prompt an initiative of using the reimbursement code service by the institution from a perspective of the institution, in this embodiment, a financial institution is introduced into the reimbursement code service, a financial account is activated by the institution at the financial institution, and serves as an actual fund expenditure party paying for a target order of the institution member, and then the institution reimburses the financial institution in a corresponding billing period. In an optional implementation provided in this embodiment, the institution account includes the financial account activated by the institution at the financial institution, for example, a fund account, a credit account, or a billing period account for which settlement is performed in a billing period settlement manner. Correspondingly, the performing payment processing based on an institution account bound to the institution includes: transferring out funds from the financial account based on an order amount carried in the reimbursement payment event, and transferring the transferred-out funds to an account of the merchant, where the funds transferred out from the financial account are prepaid by the financial institution, and the institution reimburses the financial institution for the prepaid funds in an agreed billing period.

Specifically, in a process of issuing the electronic ticket, the electronic ticket can be issued by a ticket node of a ticket issuer in the blockchain, or the electronic ticket can be issued by a reimbursement processing system. In an optional implementation provided in this embodiment, the electronic ticket is generated and uploaded by the ticket node of the ticket issuer in the blockchain, and the ticket node issues the electronic ticket in the following manner: querying, in the blockchain, institution keyword information that has a mapping relationship with the institution member; and issuing the electronic ticket of the reimbursement payment event based on the institution keyword information and the payment record that is of the reimbursement payment event and that is read from the blockchain, and performing on-chain processing.

In another optional implementation provided in this embodiment, the electronic ticket is uploaded by a reimbursement processing system that accesses the blockchain node, and the reimbursement processing system obtains the electronic ticket in the following manner: performing expense control verification on the reimbursement payment event of the institution member based on an expense control rule configured for the reimbursement code; if the expense control verification succeeds, performing payment processing based on an institution account bound to the institution, to obtain the payment record of the reimbursement payment event; and obtaining the electronic ticket submitted by the institution member, or transferring the payment record to a ticket application link activated by a merchant, to generate the electronic ticket of the reimbursement payment event.

Step S104: Perform association processing of the reimbursement payment event based on the queried payment record and electronic ticket, to obtain to-be-written-off data.

In actual application, in many scenarios, there is a case in which a plurality of reimbursement payment events are combined for reimbursement. In an example of a business trip scenario of the institution member, all reimbursement payment events in a journey of one business trip of the institution member can be combined for reimbursement, a plurality of reimbursement payment events for riding consumption in a journey of one business trip of the institution member can be combined for reimbursement, or a plurality of reimbursement payment events for food and beverage can be combined for reimbursement. In view of this, to improve reimbursement processing efficiency, in an optional implementation provided in this embodiment, association processing is performed on the reimbursement payment event. Specifically, the following manner is used for implementation: analyzing a business payment relationship between a plurality of reimbursement payment events based on element information included in payment records of the plurality of reimbursement payment events; and combining the plurality of reimbursement payment events into a business payment event based on the business payment relationship, and determining a payment record set and an electronic ticket set of the business payment event as the to-be-written-off data.

Step S106: Perform write-off processing on the to-be-written-off data, to generate a reimbursement form of the institution member, and perform on-chain processing.

After the payment record and the electronic ticket of the institution member that are queried in the blockchain are associated based on the reimbursement payment event to obtain the combined to-be-written-off data in the foregoing step, in this step, write-off processing is performed on the to-be-written-off data, to generate the reimbursement form of the institution member, to make data preparation for performing accounting processing based on the reimbursement form in a subsequent step, that is, to make data preparation for adding expenditure corresponding to the reimbursement form to expenditure of the institution based on the reimbursement form of the institution member in a subsequent step.

Step S108: Perform accounting processing based on the reimbursement form, and upload an obtained accounting voucher to the blockchain for tax declaration processing.

In specific implementation, the tax declaration processing can be performed by a tax node of a tax institution in the blockchain, or can be performed by an institution system or a third-party system (for example, a third-party tax platform or a financial management platform) that accesses the blockchain node.

If the tax declaration processing is performed by the tax node of the tax institution in the blockchain, the tax declaration processing performed by the tax node specifically includes: reading the accounting voucher of the institution from the blockchain, and creating a declaration form of the institution based on the accounting voucher; and performing tax declaration processing of the institution based on the declaration form, and uploading a tax declaration processing result to the blockchain, where the institution accesses the tax declaration processing result through the blockchain node or an institution node of the institution in the blockchain.

If the tax declaration processing is performed by the institution system or the third-party system that accesses the blockchain node, the institution system or the third-party system performs tax declaration processing in the following manner: reading the accounting voucher of the institution from the blockchain, and creating a declaration form of the institution based on the accounting voucher; and uploading the declaration form to the blockchain, to transmit the declaration form to a tax institution through the blockchain; or transferring the declaration form through a data interface provided by a tax institution, and uploading, to the blockchain, a tax declaration processing result returned by the data interface.

The following further describes, by using an example in which the blockchain-based data processing method provided in the embodiments is applied to an institution reimbursement scenario, the blockchain-based data processing method provided in the embodiments. With reference to FIG. 2, the blockchain-based data processing method applied to an institution reimbursement scenario specifically includes step S202 to step S218.

Step S202: When a reimbursement code activation application of an institution is detected and a reimbursement code is successfully generated, establish an association relationship between an institution identifier of the institution and a member identifier of an institution member, and perform on-chain storage on the institution identifier and the association relationship.

Step S204: Perform expense control verification on a reimbursement payment event of the institution member based on an expense control rule configured for the reimbursement code.

Step S206: If the expense control verification succeeds, perform payment processing based on an institution account bound to the institution, to obtain a payment record of the reimbursement payment event, and perform on-chain storage.

Step S208: Issue an electronic ticket of the reimbursement payment event based on institution keyword information and the payment record that is of the reimbursement payment event and that is read from a blockchain, and perform on-chain processing.

The institution keyword information has a mapping relationship with the institution member, and on-chain storage is also performed on the institution keyword information based on the blockchain.

Step S210: Query the payment record and the electronic ticket of the reimbursement payment event of the institution member in the blockchain after a write-off condition of the institution member is triggered.

Step S212: Perform association processing of the reimbursement payment event based on the queried payment record and electronic ticket, to obtain to-be-written-off data.

Step S214: Perform write-off processing on the to-be-written-off data, to generate a reimbursement form of the institution member, and perform on-chain processing.

Step S216: Perform accounting processing based on the reimbursement form, and upload an obtained accounting voucher to the blockchain.

Step S218: A tax node in the blockchain creates a declaration form of the institution based on the accounting voucher stored on-chain, performs tax declaration processing based on the declaration form, and uploads a tax declaration processing result to the blockchain.

An embodiment of a blockchain-based data processing apparatus provided in this specification is as follows: In the above-mentioned embodiment, a blockchain-based data processing method is provided. Correspondingly, a blockchain-based data processing apparatus is further provided, and is described below with reference to the accompanying drawings.

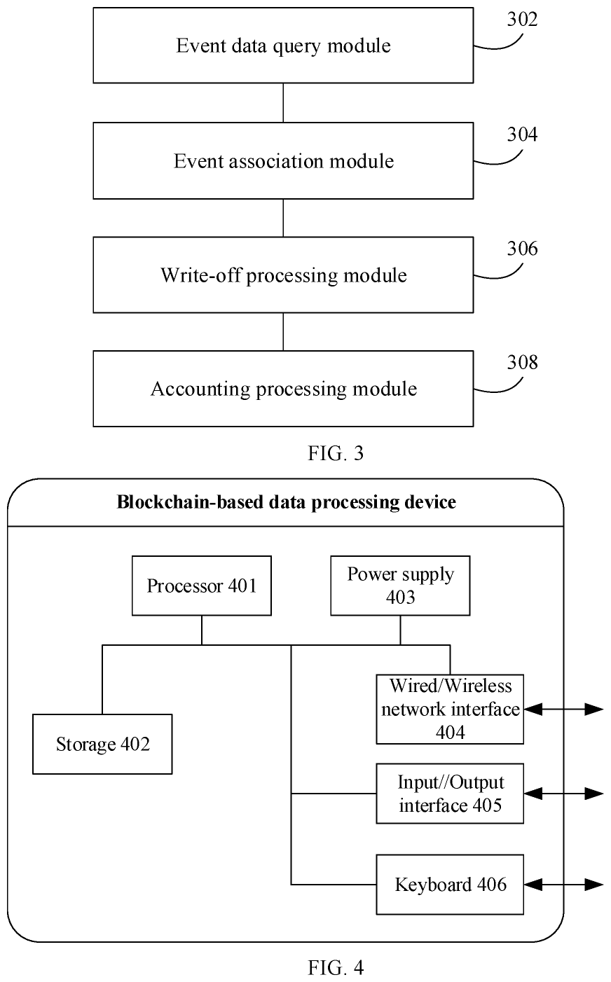

FIG. 3 is a schematic diagram of a blockchain-based data processing apparatus according to an embodiment.

The apparatus embodiment corresponds to the method embodiment, and therefore is briefly described. For a related part, refer to the corresponding description of the method embodiment provided above. The following described apparatus embodiment is merely an example.

An embodiment provides a blockchain-based data processing apparatus, running on a blockchain node in a blockchain. The blockchain is used to store a payment record and an electronic ticket that are obtained after an institution member makes a payment based on a reimbursement code of an institution. The apparatus includes: an event data query module 302, configured to query a payment record and an electronic ticket of a reimbursement payment event of the institution member in the blockchain after a write-off condition of the institution member is triggered; an event association module 304, configured to perform association processing of the reimbursement payment event based on the queried payment record and electronic ticket, to obtain to-be-written-off data; a write-off processing module 306, configured to perform write-off processing on the to-be-written-off data, to generate a reimbursement form of the institution member, and perform on-chain processing; and an accounting processing module 308, configured to perform accounting processing based on the reimbursement form, and upload an obtained accounting voucher to the blockchain for tax declaration processing.

An embodiment of a blockchain-based data processing device provided in this specification is as follows: Corresponding to the blockchain-based data processing method described above, based on the same technical concept, one or more embodiments of this specification further provide a blockchain-based data processing device. The blockchain-based data processing device is configured to perform the blockchain-based data processing method provided above. FIG. 4 is a schematic diagram of a structure of a blockchain-based data processing device according to one or more embodiments of this specification.

The blockchain-based data processing device provided in this embodiment includes the following: As shown in FIG. 4, the blockchain-based data processing device can differ greatly due to different configurations or performance, and can include one or more processors 401 and a storage 402. The storage 402 can store one or more storage applications or data. The storage 402 can be a temporary storage or a persistent storage. The application stored in the storage 402 can include one or more modules (not shown in the figure), and each module can include a series of computer-executable instructions in the blockchain-based data processing device. Further, the processor 401 can be configured to communicate with the storage 402, to execute a series of computer-executable instructions in the storage 402 on the blockchain-based data processing device. The blockchain-based data processing device can further include one or more power supplies 403, one or more wired or wireless network interfaces 404, one or more input/output interfaces 405, one or more keyboards 406, and the like.

In a specific embodiment, the blockchain-based data processing device includes a storage and one or more programs. The one or more programs are stored in the storage, and the one or more programs can include one or more modules. Each module can include a series of computer-executable instructions in the blockchain-based data processing device, and the one or more processors are configured to execute the one or more program, to execute the following computer-executable instructions: querying a payment record and an electronic ticket of a reimbursement payment event of an institution member in a blockchain after a write-off condition of the institution member is triggered, where the blockchain is used to store a payment record and an electronic ticket that are obtained after the institution member makes a payment based on a reimbursement code of an institution; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

An embodiment of a storage medium provided in this specification is as follows: Corresponding to the blockchain-based data processing method described above, based on the same technical concept, one or more embodiments of this specification further provide a storage medium.

The storage medium provided in this embodiment is configured to store computer-executable instructions. When the computer-executable instructions are executed, the following procedure is implemented: querying a payment record and an electronic ticket of a reimbursement payment event of an institution member in a blockchain after a write-off condition of the institution member is triggered, where the blockchain is used to store a payment record and an electronic ticket that are obtained after the institution member makes a payment based on a reimbursement code of an institution; performing association processing of the reimbursement payment event based on the queried payment record and electronic ticket, to obtain to-be-written-off data; performing write-off processing on the to-be-written-off data, to generate a reimbursement form of the institution member, and performing on-chain processing; and performing accounting processing based on the reimbursement form, and uploading an obtained accounting voucher to the blockchain for tax declaration processing.

It is worthwhile to note that the embodiment of the storage medium in this specification and the embodiment of the blockchain-based data processing method in this specification are based on the same inventive concept. Therefore, for specific embodiment of this embodiment, references can be made to the implementation of the corresponding method, and repeated parts are omitted for simplicity.

Specific embodiments of this specification are described above. Other embodiments fall within the scope of the appended claims. In some cases, actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multi-tasking and parallel processing are feasible or may be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can also be implemented as a part of the control logic of the storage. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, and the like. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when the embodiments of this specification are implemented, functions of the units can be implemented in one or more pieces of software and/or hardware.

A person skilled in the art should understand that one or more embodiments of this specification can be provided as methods, systems, or computer program products. Therefore, one or more embodiments of this specification can use a form of hardware only embodiments, software only embodiments, or embodiments with a combination of software and hardware. In addition, a form of a computer program product that is implemented on one or more computer-usable storage media (including but not limited to a disk storage, a CD-ROM, an optical storage, or the like) that include computer-usable program code can be used in this specification.

This specification is described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a magnetic disk storage, or another magnetic storage device or any other non-transmission medium. The computer storage medium can be configured to store information that can be accessed by a computing device. As described in this specification, the computer-readable medium does not include computer-readable transitory media such as a modulated data signal and a carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

One or more embodiments of this specification can be described in the general context of computer-executable instructions, for example, a program module. Generally, the program module includes a routine, a program, an object, a component, a data structure, and the like for executing a specific task or implementing a specific abstract data type. One or more embodiments of this specification can alternatively be practiced in distributed computing environments. In the distributed computing environments, tasks are performed by remote processing devices connected through a communication network. In the distributed computing environments, the program module can be located in a local and remote computer storage medium including a storage device.

The embodiments in this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely embodiments of this specification, and are not intended to limit this specification. A person skilled in the art can make various changes and variations to this specification. Any modification, equivalent replacement, or improvement made without departing from the spirit and principle of this specification shall fall within the scope of the claims of this specification.

1. A data processing method, applied to a blockchain node in a blockchain, wherein the blockchain is used to store a payment record and an electronic ticket that are obtained after an institution member makes a payment based on a reimbursement code of an institution, and the method comprises:
querying a payment record and an electronic ticket of a reimbursement payment event of the institution member in the blockchain after a write-off condition of the institution member is triggered;
performing association processing of the reimbursement payment event based on the queried payment record and electronic ticket, to obtain to-be-written-off data;
performing write-off processing on the to-be-written-off data, to generate a reimbursement form of the institution member, and performing on-chain processing; and
performing accounting processing based on the reimbursement form, and uploading an obtained accounting voucher to the blockchain for tax declaration processing.

2. The data processing method according to claim 1, wherein the blockchain is further used to store an institution identifier of the institution and an association relationship between the institution and the institution member, and the method further comprises:
obtaining the institution identifier of the institution and a member identifier of the institution member of the institution when a reimbursement code activation application of the institution is detected and the reimbursement code is successfully generated; and
establishing an association relationship between the institution identifier and the member identifier, and uploading the institution identifier and the association relationship to the blockchain.

3. The data processing method according to claim 2, wherein the reimbursement code of the institution is activated in the following manner:
detecting, based on a reimbursement code activation request, whether the institution is an authenticated institution, or whether an institution member submitting the reimbursement code activation request is an institution owner of the institution; and
upon determining that the institution is an authenticated institution or the institution member submitting the reimbursement code activation request is an institution owner of the institution, generating the reimbursement code, delivering the reimbursement code to the institution or the institution member submitting the reimbursement code activation request, and establishing a binding relationship between the institution and a submitted institution account.

4. The data processing method according to claim 3, wherein before the step of querying a payment record and an electronic ticket of a reimbursement payment event of the institution member in the blockchain after a write-off condition of the institution member is triggered, the method further comprises:
performing expense control verification on the reimbursement payment event of the institution member based on an expense control rule configured for the reimbursement code; and
upon determining that the expense control verification succeeds, performing payment processing based on an institution account bound to the institution, to obtain the payment record of the reimbursement payment event, and uploading the payment record to the blockchain.

5. The data processing method according to claim 1, further comprising:
sending an activation invitation of the reimbursement code to the institution member based on an activation request submitted by the institution for the institution member;
performing identity verification processing on the institution member when a confirmation instruction submitted by the institution member for the activation invitation is detected; and
when the identity verification processing succeeds, establishing a mapping relationship between the institution member and institution keyword information of the institution, and uploading the mapping relationship to the blockchain.

6. The data processing method according to claim 5, wherein the electronic ticket is generated and uploaded by a ticket node of a ticket issuer in the blockchain, and the ticket node issues the electronic ticket in the following manner:
querying, in the blockchain, institution keyword information that has a mapping relationship with the institution member; and
issuing the electronic ticket of the reimbursement payment event based on the institution keyword information and the payment record that is of the reimbursement payment event and that is read from the blockchain, and performing on-chain processing.

7. The data processing method according to claim 1, wherein the write-off condition of the institution member comprises at least one of the following:
a reimbursement limit allocated by the institution to the institution member for the reimbursement code is exhausted, and a ticket application control of the reimbursement payment event of the institution member is triggered; and
the ticket application control is configured on a payment completion page generated after a payment of the reimbursement payment event is completed.

8. The data processing method according to claim 1, wherein the electronic ticket is uploaded by a reimbursement processing system that accesses the blockchain node, and the reimbursement processing system obtains the electronic ticket in the following manner:
performing expense control verification on the reimbursement payment event of the institution member based on an expense control rule configured for the reimbursement code;
upon determining that the expense control verification succeeds, performing payment processing based on an institution account bound to the institution, to obtain the payment record of the reimbursement payment event; and
obtaining the electronic ticket submitted by the institution member, or transferring the payment record to a ticket application link activated by a merchant, to generate the electronic ticket of the reimbursement payment event.

9. The data processing method according to claim 1, wherein the performing association processing of the reimbursement payment event based on the queried payment record and electronic ticket, to obtain to-be-written-off data comprises:
analyzing a business payment relationship between a plurality of reimbursement payment events based on element information comprised in payment records of the plurality of reimbursement payment events; and
combining the plurality of reimbursement payment events into a business payment event based on the business payment relationship, and determining a payment record set and an electronic ticket set of the business payment event as the to-be-written-off data.

10. The data processing method according to claim 1, wherein the tax declaration processing is performed by a tax node of a tax institution in the blockchain, and the tax declaration processing performed by the tax node comprises:
reading the accounting voucher of the institution from the blockchain, and creating a declaration form of the institution based on the accounting voucher; and
performing tax declaration processing of the institution based on the declaration form, and uploading a tax declaration processing result to the blockchain, wherein the institution accesses the tax declaration processing result through the blockchain node or an institution node of the institution in the blockchain.

11. The data processing method according to claim 1, wherein the tax declaration processing is performed by an institution system or a third-party system that accesses the blockchain node, and the institution system or the third-party system performs tax declaration processing in the following manner:
reading the accounting voucher of the institution from the blockchain, and creating a declaration form of the institution based on the accounting voucher; and
uploading the declaration form to the blockchain, to transmit the declaration form to a tax institution through the blockchain; or transferring the declaration form through a data interface provided by a tax institution, and uploading, to the blockchain, a tax declaration processing result returned by the data interface.

12. The data processing method according to claim 8, wherein the expense control verification is implemented in the following manner:
determining a target reimbursement category that matches the reimbursement payment event in at least one reimbursement category of the expense control rule;
verifying whether element information carried in the reimbursement payment event falls within a value range of an expense control element associated with the target reimbursement category; and
upon determining that element information carried in the reimbursement payment event falls within the value range of the expense control element associated with the target reimbursement category, determining that verification on the reimbursement payment event in terms of the target reimbursement category succeeds.

13. The data processing method according to claim 8, wherein the institution account comprises a financial account activated by the institution at a financial institution; and
correspondingly, the performing payment processing based on an institution account bound to the institution comprises:
transferring out funds from the financial account based on an order amount carried in the reimbursement payment event, and transferring the transferred-out funds to an account of the merchant, wherein
the funds transferred out from the financial account are prepaid by the financial institution, and the institution reimburses the financial institution for the prepaid funds in an agreed billing period.

14. (canceled)

15. A data processing device, comprising:
a memory and a processor, wherein the memory stores executable instructions that, in response to execution by the processor, cause the processor to:
query a payment record and an electronic ticket of a reimbursement payment event of an institution member in a blockchain after a write-off condition of the institution member is triggered, wherein the blockchain is used to store a payment record and an electronic ticket that are obtained after the institution member makes a payment based on a reimbursement code of an institution;
perform association processing of the reimbursement payment event based on the queried payment record and electronic ticket, to obtain to-be-written-off data;
perform write-off processing on the to-be-written-off data, to generate a reimbursement form of the institution member, and perform on-chain processing; and
perform accounting processing based on the reimbursement form, and upload an obtained accounting voucher to the blockchain for tax declaration processing.

16. A non-transitory computer-readable storage medium, comprising instructions stored therein that, when executed by a processor of a computer device, cause the processor to:
query a payment record and an electronic ticket of a reimbursement payment event of an institution member in a blockchain after a write-off condition of the institution member is triggered, wherein the blockchain is used to store a payment record and an electronic ticket that are obtained after the institution member makes a payment based on a reimbursement code of an institution;
perform association processing of the reimbursement payment event based on the queried payment record and electronic ticket, to obtain to-be-written-off data;
perform write-off processing on the to-be-written-off data, to generate a reimbursement form of the institution member, and perform on-chain processing; and
perform accounting processing based on the reimbursement form, and upload an obtained accounting voucher to the blockchain for tax declaration processing.
